(19) United States
(12) Patent Application Publication
(10) Pub. No.: US 2023/0156880 A1
(43) Pub. Date: May 18, 2023

(54) DRIVING CIRCUIT AND VOLTAGE MODULATION METHOD

(71) Applicant: NOVATEK Microelectronics Corp., Hsinchu (TW)

(72) Inventors: Yi-Je SUEN, Taichung City (TW); Po-Hsiang FANG, Hsinchu County (TW); Jhih-Siou CHENG, New Taipei City (TW); Yung-Te CHANG, Hsinchu County (TW); Hung-Ho HUANG, Hsinchu City (TW)

(21) Appl. No.: 17/650,855

(22) Filed: Feb. 14, 2022

Related U.S. Application Data
(60) Provisional application No. 63/264,046, filed on Nov. 15, 2021.

(51) Int. Cl. H05B 45/10; H05B 45/30

(52) U.S. Cl. CPC H05B 45/10; H05B 45/30

(57) ABSTRACT

The present disclosure provides a driving circuit, configured to couple to a light emitting diode (LED) and a power supply circuit. The driving circuit includes a comparator, a serial input interface, and an integrating unit. The comparator is configured to couple to the LED and determine whether a cathode voltage of the LED is lower than a threshold value and generate a monitoring data. The serial input interface is configured to receive a serial input data from a previous driving circuit. The integrating unit is coupled to the comparator and the serial input interface and configured to integrate the monitoring data and the serial input data to generate an output data. The output data is transmitted to a following driving circuit or feedbacked to the power supply circuit in order to modulate a power voltage that the power circuit provides to the LED.

### CROSS - REFERENCE TO RELATED APPLICATION

This application claims priority to U.S. Provisional Application Serial No. 63/264,046, filed Nov. 15, 2021, which is herein incorporated by reference in its entirety.

### BACKGROUND

### Field of Invention

The present invention relates to a driving circuit and a voltage modulation method. More particularly, the present invention relates to a driving circuit and a voltage modulation method both able to modulate a power voltage.

### Description of Related Art

For most display devices on the market, the driver integrated circuits (IC) that control the currents passing through the light emitting diodes (LEDs) in the display device need a common bus system in order to communicate information about whether the driving voltage is large enough to drive the LEDs. In this approach, extra pins are required for all driver ICs in order to communicate through the common bus system, and thus the cost and complexity to manufacture the driver ICs increase.

### SUMMARY

The present disclosure provides a driving circuit, coupled to a light emitting diode and a power supply circuit and configured to control the power supply circuit to provide power to the light emitting diode. The driving circuit includes a comparator, a serial input interface, and an integrating unit. The comparator is coupled to the light emitting diode and configured to determine whether a voltage at the light emitting diode’s cathode is lower than a threshold value and to generate a monitoring data. The serial input interface is configured to receive a serial input data from a previous driving circuit. The integrating unit is coupled to the comparator and the serial input interface and configured to integrate the monitoring data and the serial input data to generate an output data. The output data is transmitted to a following driving circuit or feedbacked to the power supply circuit in order to modulate a power voltage provided by the power circuit provides to the light emitting diode.

The present disclosure also provides a voltage modulation method, including determining whether a cathode voltage of a light emitting diode is lower than a threshold value and generating a monitoring data; receiving a serial input data from a previous driving circuit; integrating the monitoring data and the serial input data to generate an output data; and transmitting the output data to a following driving circuit or feeding back the output data to a power supply circuit in order to modulate a power voltage that the power circuit provides to the light emitting diode.

### BRIEF DESCRIPTION OF THE DRAWINGS

The invention can be more fully understood by reading the following detailed description of the embodiment, with reference made to the accompanying drawings as follows:

FIG. 1 is a circuit diagram of a display device in accordance with some embodiments of the present disclosure.

FIG. 2 is a circuit diagram of a driving circuit in accordance with some embodiments of the present disclosure.

FIG. 3A is a time sequence diagram of signals that a driving circuit transmits and receives in accordance with some embodiments of the present disclosure.

FIG. 3B is a time sequence diagram of signals that a driving circuit transmits and receives in accordance with some embodiments of the present disclosure.

FIG. 3C is a time sequence diagram of signals that a driving circuit transmits and receives in accordance with some embodiments of the present disclosure.

FIG. 3D is a time sequence diagram of signals that a driving circuit transmits and receives in accordance with some embodiments of the present disclosure.

FIG. 3E is a time sequence diagram of signals that a driving circuit transmits and receives in accordance with some embodiments of the present disclosure.

FIG. 4 is a circuit diagram of a driving circuit in accordance with some embodiments of the present disclosure.

FIG. 5 is a circuit diagram of a driving circuit in accordance with some embodiments of the present disclosure.

FIG. 6 is a flowchart of a voltage modulation method in accordance with some embodiments of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

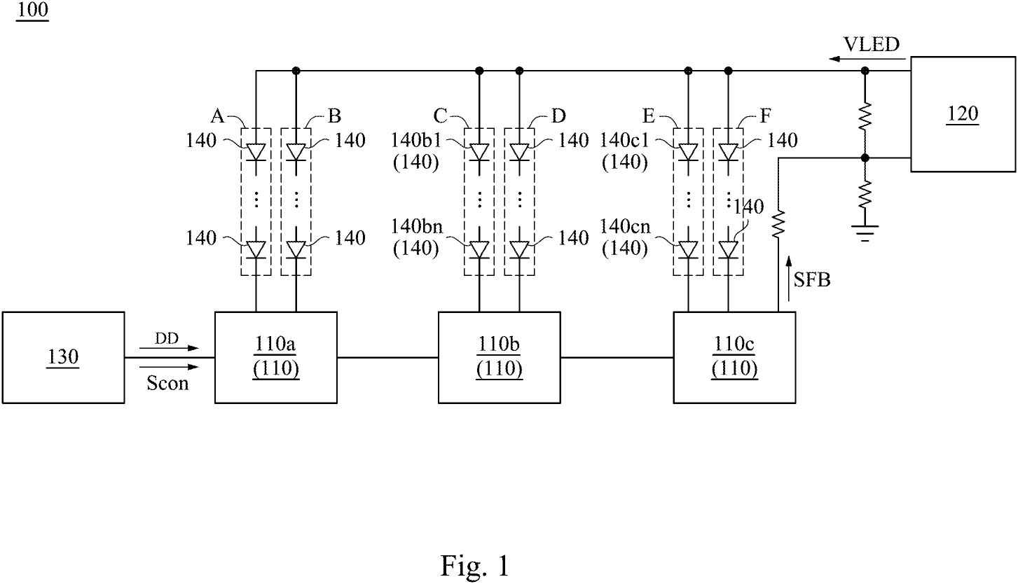

Please refer to FIG. 1. FIG. 1 is a circuit diagram of a display device 100 in accordance with some embodiments of the present disclosure. The display device 100 includes multiple driving circuits 110, a power supply circuit 120, a control unit 130, and multiple light emitting diodes (LEDs) 140 coupled between the power supply circuit 120 and the corresponding driving circuits 110. In one embodiment, the display device 100 is a display panel, a touch panel, a television or a smart television including a LED backlight module or a colored LED panel.

In some embodiments, the power supply circuit 120 is configured to provide a power voltage VLED to anodes of the light emitting diodes 140. In one embodiment, the power supply circuit 120 is a DC-to-DC converter or a low-dropout (LDO) regulator.

In some embodiments, one of the driving circuits 110 (e.g., the latest driving circuits 110c in the embodiment shown in FIG. 1) is coupled with the power supply circuit 120 and the driving circuit 110c is configured to generate a feedback control signal SFB to the power supply circuit 120 for modulating the power voltage VLED provided by the power supply circuit 120.

Each driving circuit 110 electrically connects to a plurality of LEDs 140. In the embodiment shown in FIG. 1, each driving circuit 110 connects to two columns of LEDs 140. As shown in FIG. 1, the driving circuit 110a connects to the LED columns A and B, the driving circuit 110b connects to the LED columns C and D, and the driving circuit 110c connects to the LED columns E and F. It should be noted that the number of the LED columns is merely exemplary. In some embodiments, the driving circuits 110 electrically connect to an array of LEDs 140 that consists of more than six columns of LEDs 140.

In one embodiment, the control unit 130 includes a data driver for providing display data DD to be displayed on the array of LEDs 140 in the display device 100 and also a time controller (TCON) configured to transmit clock signals to the driving circuits 110.

In some embodiments, the driving circuits 110 are configured to control driving currents passing through the LEDs 140 according to the display data DD. Specifically, the control unit 130 generates the display data DD and passes it to the driving circuits 110a, 110b, and 110c through a serial transmission. According to such display data DD, the driving circuit 110a controls the currents of the LEDs 140 in the LED columns A and B, the driving circuit 110b controls the currents of the LEDs 140 in the LED columns C and D, and the driving circuit 110c controls the currents in the LEDs 140 of the LED columns E and F.

In the embodiment shown in FIG. 1, there are only three driving circuits 110, i.e., the driving circuits 110a, 110b, 110c. It should be noted that the number of the driving circuits 110 in the display device 100 is merely exemplary, and person having ordinary skills in the art can modify such number according to actual needs or design.

In some embodiments, the display data DD generated by the control unit 130 contain data about the images that will be displayed through the LEDs 140. For example, the display data DD transmitted to the driving circuit 110a can define the brightness of the LEDs 140 in the LED columns A and B. In some embodiments, the display data DD carry a series of brightness codes, e.g., [0, 155, 30, 34, 50, 70], and the codes correspond to the LED columns A, B, C, D, E, and F. Specifically, the driving circuit 110a will receive the codes [0, 155] and control the brightness of the LED columns A and B correspondingly, the driving circuit 110b will receive the codes [30, 34] and control the brightness of the LED columns C and D correspondingly, and the driving circuit 110c will receive the codes [50, 70] and control the brightness of the LED columns E and F correspondingly. In other words, the display data DD represent the brightness of the LEDs 140. In some embodiments, the display data DD are about the image frame to be displayed through the LED array.

The power supply circuit 120 is configured to drive the LEDs 140 in the display device 100. Specifically, the power supply circuit 120 generates the power voltage VLED and provides it to the anode of the topmost LED 140 in each LED column, such as the LED 140b1 in the LED column C. When the power voltage VLED is large enough to create sufficient voltage difference between the two ends of each LED columns A, B, C, D, E, and F, all LEDs 140 in the display device 100 can operate properly. Specifically, one LED 140 is able to operate in light-emitting when the voltage difference between its anode and cathode is greater than or equal to the forward voltage (Vf) of that LED 140, so in order to drive multiple LEDs 140 coupled in series in one LED column, e.g., the LEDs 140b1~140bn in the LED column C, the power voltage VLED has to be equal to or greater than n*Vf.

Because the forward voltages (Vf) for each of the LEDs 140 can be slightly different due to a manufacturing bias or a temperature conduction, if the power voltage VLED provided by the power supply circuit 120 is fixed, the fixed power voltage VLED may not be high enough to light up all LEDs 140 in every LED column. However, if the power supply circuit 120 provides the power voltage VLED with a relatively higher level that is way over a required level needed by the LED array, it will cost extra power consumption and be not power efficient. In some embodiments, the driving circuits 110 are able to detect cathode voltages on these LED columns and generate the feedback control signal SFB to the power supply circuit 120 for modulating the power voltage VLED (e.g., raising a voltage level of the power voltage VLED).

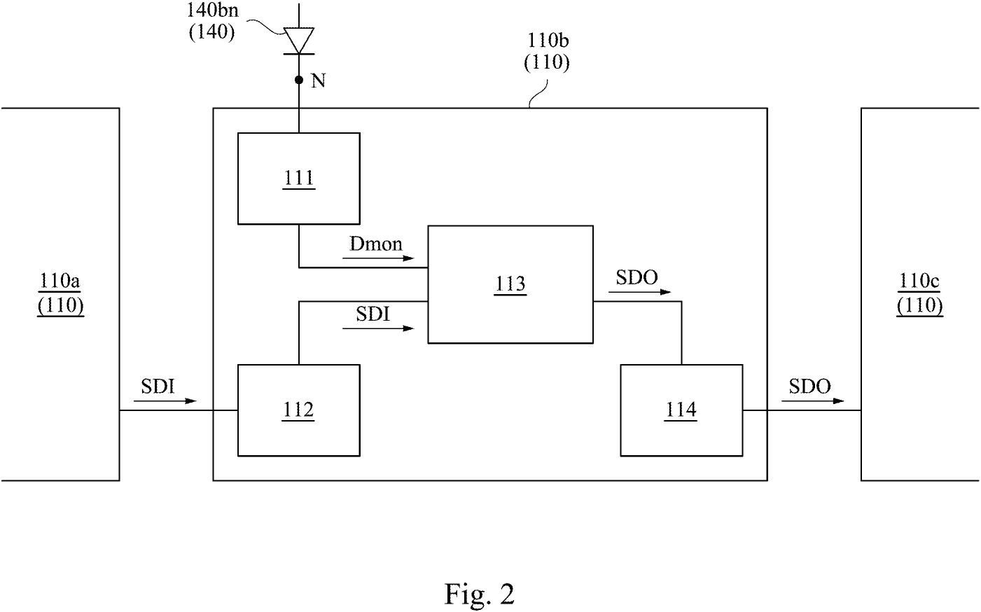

The mechanism for modulating the power voltage VLED is discussed below. Please refer to FIG. 1 and FIG. 2. FIG. 2 is a circuit diagram of the driving circuit 110b in accordance with some embodiments of the present disclosure. Here, the driving circuit 110b shown in FIG. 1 is used as an example for explanatory purpose. The other driving circuit 110, such as the driving circuit 110a, can have the same components as the driving circuit 110b shown in FIG. 2.

The driving circuit 110b includes a comparator 111, a serial input interface 112, and an integrating unit 113. As shown in FIG. 1 and FIG. 2, the driving circuit 110b is coupled to the driving circuit 110a and the driving circuit 110c. For the purpose of simplicity, in the embodiment shown in FIG. 2, only the LED column C couples to the driving circuit 110b, and the LED column D shown in FIG. 1 is omitted here. Thus, in the embodiment shown in FIG. 2, the driving circuit 110b is coupled to the LED column C (not shown in FIG. 1), specifically to the LED 140bn.

The comparator 111 is coupled to the LED 140bn and configured to determine whether the cathode voltage of the LED 140bn (i.e., the voltage at the node N) is lower than a threshold value and to generate a monitoring data Dmon. Specifically, the comparator 111 receives the voltage at the node N and compares it with the predetermined threshold value, in order to determine whether a higher voltage should be provided to the LED 140bn (i.e., whether the power voltage VLED configured to drive all LEDs 140 in the display device 100 needs to be stepped up). In one embodiment, the threshold value is predetermined by the designer or manufacturer of the display device 100.

In one embodiment, when the comparator 111 determines that the voltage at the node N is lower than the threshold value, the monitoring data Dmon has a first level, while when the comparator 111 determines that the voltage at the node N is higher than the threshold value, the monitoring data Dmon has a second level. The monitoring data Dmon having the first level indicates that the power voltage VLED needs to be stepped up, and the monitoring data Dmon having the second level indicates that the power voltage VLED is large enough and does not need to be raised. In one embodiment, the monitoring data is a digital data, the first level is high logic level, and the second level is low logic level. In one embodiment, the monitoring data is an analog data, the first level is a higher voltage level, and the second level is lower voltage level.

The serial input interface 112 is configured to receive a serial input data SDI from a previous driving circuit, i.e., the driving circuit 110a in the embodiment shown in FIG. 2. The serial input data SDI include both the display data DD generated by the control unit 130 as shown in FIG. 1 and the data about the cathode voltages of the LEDs 140 that are monitored by the driving circuit 110a. As previously discussed, the driving circuit 110a has the same components as the driving circuit 110b and thus the driving circuit 110a includes the comparator 111 configured to monitor cathode voltages of the LEDs 140 coupled to it. How the display data DD and the data about the voltage of the LEDs 140 monitored by the driving circuit 110a are transmitted through the serial input data SDI in different time periods will be discussed in later paragraphs. Below first discuss how the data about the voltage of the LEDs 140 monitored by the driving circuit 110a and the data about the voltage of the LEDs 140 monitored by the driving circuit 110b are integrated.

The integrating unit 113 is coupled to the comparator 111 and the serial input interface 112 and configured to integrate the monitoring data Dmon and the serial input data SDI to generate an output data SDO. The output data SDO is then transmitted to a following driving circuit, which is the driving circuit 110c in this embodiment. The monitoring data Dmon indicate that whether the power voltage VLED is sufficiently large to drive the LED column C, and the serial input data SDI indicate that whether the power voltage VLED is sufficiently large to drive the LEDs 140 coupled to the driving circuit 110a (e.g., the LEDs 140 of the LED columns A and B in FIG. 1). Thus, the integrating unit 113 is configured to combine the information about the cathode voltages monitored by the driving circuits 110a and 110b and pass such information to the driving circuit 110c.

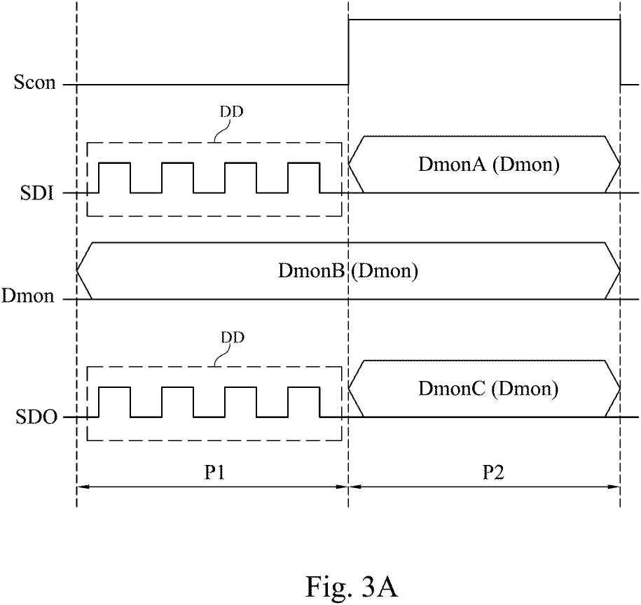

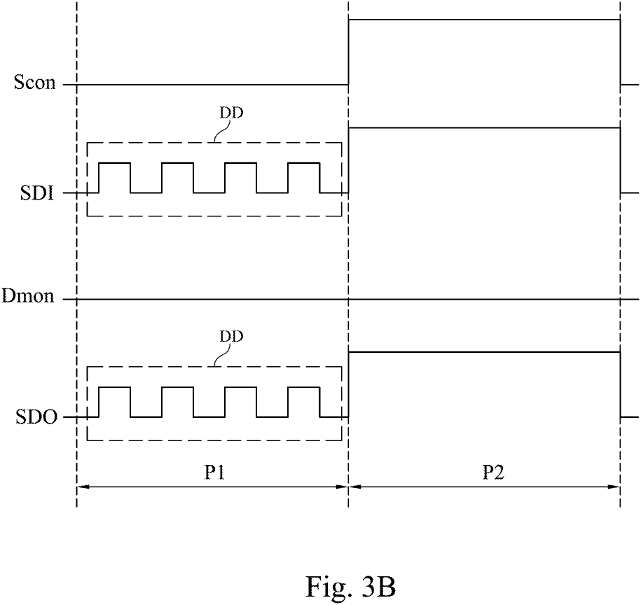

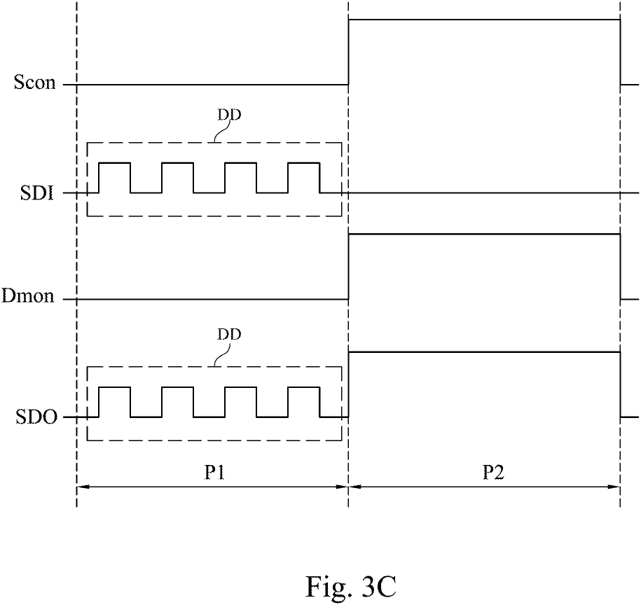

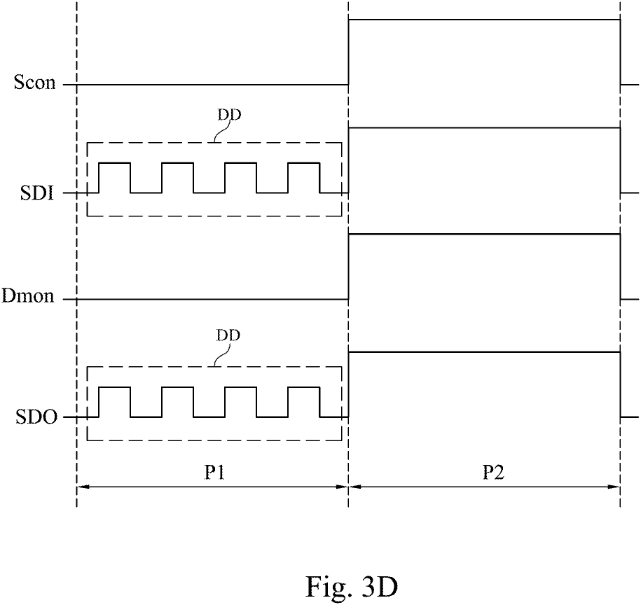

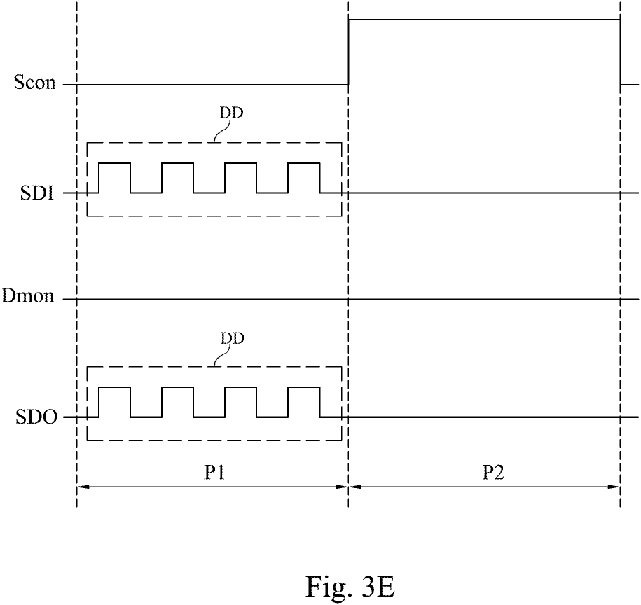

Specifically, in one embodiment, the integrating unit 113 sets the output data SDO as the first level when the monitoring data Dmon has the first level or the serial input data SDI has the first level. That is, when either of the monitoring data Dmon and the serial input data SDI has the first level, the output data SDO generated by the integrating unit 113 has the first level. In other words, when either of the driving circuit 110a and the driving circuit 110b determines that the power voltage VLED is not sufficient to drive the LEDs 140 coupled to them and that the power voltage VLED needs to be stepped up, the output data SDO is set as the first level. The output data SDO generated by the integrating unit 113 with the first level is configured to trigger the power supply circuit 120 to raise the power voltage VLED. On the other hand, in one embodiment, the integrating unit 113 sets the output data SDO as the second level when both the monitoring data Dmon and the serial input data SDI have the second level. In other words, when both of the driving circuit 110a and 110b determine that the power voltage VLED is sufficient to drive the LEDs 140 coupled to them and that the power voltage VLED does not need to be stepped up, the output data is set as the second level. The output data SDO generated by the integrating unit 113 with the second level is configured to trigger the power supply circuit 120 to maintain the power voltage VLED. These two embodiments can also be understood through the embodiments in FIGS. 3A, 3B, 3C, 3D, and 3E. More details will be discussed in later paragraphs.

In one embodiment, the serial input data SDI and/or the output data SDO is a digital data, the first level is high logic level, and the second level is low logic level. In one embodiment, the serial input data SDI and/or the output data SDO is an analog data, the first level is a higher voltage level, and the second level is lower voltage level.

In one embodiment, the output data SDO is transmitted to a serial output interface 114 as shown in FIG. 2, and the serial output interface 114 transmits the output data SDO to the driving circuit 110c. Therefore, through the combination and operation of the components of the driving circuit 110b, the information about the voltage of the LEDs 140 coupled to the driving circuit 110a (which is contained in the serial input data SDI) and the information about the voltage of the LEDs 140 coupled to the driving circuit 110b (which is contained in the monitoring data Dmon) can be integrated together and passed to the driving circuit 110c in the form of the output data SDO. In some embodiments, the output data SDO can be referred to as a multi-chip communication signal, which contains the information collected by more than one chip (i.e., the driving circuit 110 in the present disclosure).

Please refer to FIG. 2 and FIG. 3A. FIG. 3A is a time sequence diagram of the signals that the driving circuit 110b transmits and receives in accordance with some embodiments of the present disclosure. As pointed out in the paragraphs above, the display data DD is also contained in the serial input data SDI. To be more specific, in one embodiment, the integrating unit 130 integrates the monitoring data Dmon and the serial input data SDI in a time-dividing manner, in which the integrating unit 130 bypasses the display data DD carried in the serial input data SDI as the output data SDO during a first period P1 and combines the monitoring data Dmon with the serial input data SDI as the output data SDO during a second period P2. The first period P1 and the second period P2 do not overlap.

The serial input data SDI in FIG. 3A are the data received by the serial input interface 112 of the driving circuit 110b as shown in FIG. 2, the monitoring data Dmon in FIG. 3A are the data monitored by the comparator 111 and transmitted to the integrating unit 113 as shown in FIG. 2, and the output data SDO in FIG. 3A are the data generated by the integrating unit 113 as shown in FIG. 2. The control signal Scon in FIG. 3A is configured to control the driving circuit 110b to operate in the first period P1 or the second period P2. In one embodiment, the control signal Scon is provided by the control unit 130 as shown in FIG. 1. In the embodiment shown in FIG. 3A, the display data DD is a square wave during the first period P1. It is worth noted that the square wave of the display data DD shown in FIG. 3A is merely exemplary, and that the display data DD can have a waveform other than the square wave. During the first period P1, the control signal Scon has a low logic level and the driving circuit 110b operates in the first period P1. During the second period P2, the control signal Scon has a high logic level and the driving circuit 110b operates in the second period P2.

As shown in FIG. 3A, the display data DD is transmitted through the serial input data SDI during the first period P1, and the monitoring data DmonA is transmitted through the serial input data SDI during the second period P2. The monitoring data DmonA refer to the monitoring data that the comparator 111 of the driving circuit 110a generates according to the cathode voltage of the LEDs 140 coupled to the driving circuit 110a, and the monitoring data DmonA is transmitted to the driving circuit 110b from the serial output interface 114 of the driving circuit 110a. The monitoring data DmonB refer to the monitoring data that the comparator 111 of the driving circuit 110b generates and transmits to the integrating unit 113 of the driving circuit 110b. The output data SDO refer to the data that the integrating unit 113 of the driving circuit 110b generates by integrating the monitoring data Dmon and the serial input data SDI in the time-dividing manner mentioned above.

Specifically, in the embodiment shown in FIG. 3A, during the first period P1, the display data DD is transmitted through the serial input data SDI, and, although the integrating unit receives the monitoring data DmonB, because the integrating unit 113 does not combine the monitoring data Dmon with the serial input data SDI during the first period P1, the integrating unit 113 simply outputs the display data DD as the output data SDO.

During the second period P2, the monitoring data DmonA is transmitted through the serial input data SDI, and because the integrating unit 113 combines the monitoring data Dmon with the serial input data SDI as the output data SDO during the second period P2, the integrating unit 113 integrates the monitoring data DmonA and the monitoring data DmonB into the monitoring data DmonC in the second period P2.

In one embodiment, the serial input interface 112, the integrating unit 113, and the serial output interface 114 operate in the second period P2 when the control signal Scon has the first level, and the serial input interface 112, the integrating unit 113, and the serial output interface 114 operate in the first period P1 when the control signal Scon has the second level. In one embodiment, the first level is high logic level, and the second level is low logic level.

Please refer to FIG. 3B. FIG. 3B is a time sequence diagram of the signals that the driving circuit 110b transmits and receives in accordance with some embodiments of the present disclosure. In one embodiment, the serial input data SDI during the second period P2 (i.e., the monitoring data DmonA in FIG. 3A) has a high voltage level, which indicates that according to the cathode voltage monitored by the comparator 111 of the driving circuit 110a the power voltage VLED needs to be stepped up; the monitoring Dmon has a low voltage level, which indicates that according to the cathode voltage monitored by the comparator 111 of the driving circuit 110b the power voltage VLED does not need to be stepped up. Therefore, the output data SDO during the second period P2 (i.e., the monitoring data DmonC in FIG. 3A) has a high voltage level as the output data SDO is generated by combining the serial input data SDI and the monitoring data Dmon during the second period P2.

Please refer to FIG. 3C. FIG. 3C is a time sequence diagram of the signals that the driving circuit 110b transmits and receives in accordance with some embodiments of the present disclosure. In one embodiment, the serial input data SDI during the second period P2 has a low voltage level, which indicates that according to the cathode voltage monitored by the comparator 111 of the driving circuit 110a the power voltage VLED does not need to be stepped up; the monitoring Dmon has a high voltage level, which indicates that according to the cathode voltage monitored by the comparator 111 of the driving circuit 110b the power voltage VLED needs to be stepped up. Therefore, the output data SDO during the second period P2 has a high voltage level.

Please refer to FIG. 3D. FIG. 3D is a time sequence diagram of the signals that the driving circuit 110b transmits and receives in accordance with some embodiments of the present disclosure. In one embodiment, both the serial input data SDI and the monitoring Dmon during the second period P2 have high voltage levels. Therefore, the output data SDO during the second period P2 has a high voltage level.

Please refer to FIG. 3E. FIG. 3E is a time sequence diagram of the signals that the driving circuit 110b transmits and receives in accordance with some embodiments of the present disclosure. In one embodiment, both the serial input data SDI and the monitoring Dmon during the second period P2 have low voltage levels. Therefore, the output data SDO during the second period P2 has a low voltage level, which indicates that according to the cathode voltages monitored by the comparators 111 of the driving circuits 110a and 110b the power voltage VLED does not need to be stepped up.

In one embodiment, one or all of the monitoring data Dmon, the serial input data SDI, and the output data SDO is digital data, which has a high logic level or a low logic level. In one embodiment, one or all of the monitoring data Dmon, the serial input data SDI, and the output data SDO is analog data, which can have different voltage level, e.g., 0V, 1V, 2V, 3V, and others alike.

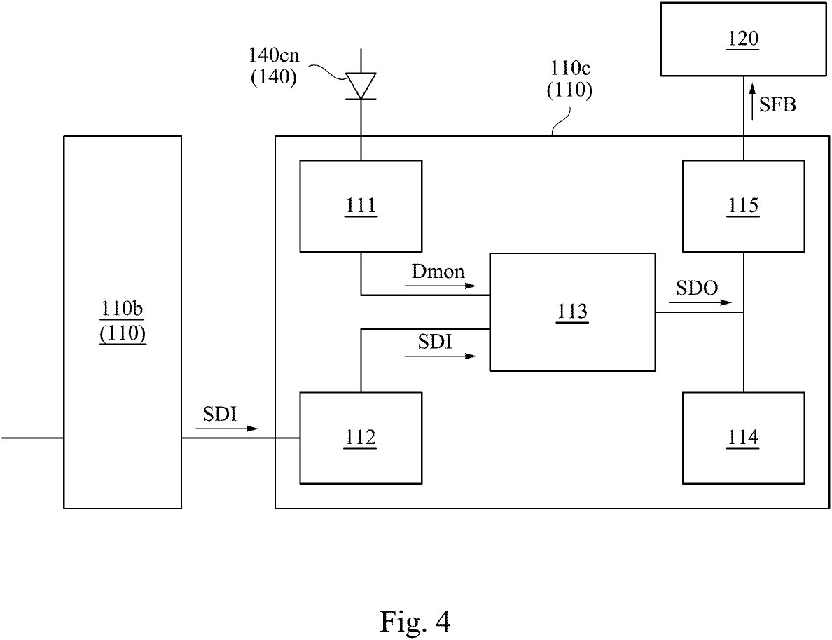

Please refer to FIG. 1 and FIG. 4. FIG. 4 is a circuit diagram of the driving circuit 110c in accordance with some embodiments of the present disclosure. The driving circuit 110c includes the same components as the driving circuit 110b (i.e., the comparator 111, the serial input interface 112, the integrating unit 113, and the serial output interface 114) and a feedback generator 115. Detailed description of the previous embodiments can be referred to. The feedback generator 115 is configured to receive the output data SDO and generate the feedback control signal SFB to the power supply circuit 120. In some embodiments, the feedback generator 115 is configured to extract the monitoring data DmonC in the second period P2, as shown in FIG. 3A, from the output data SDO. The monitoring data DmonC reflect whether the cathode voltages of the LEDs 140 coupled to the driving circuits 110 are lower than the threshold voltage. The feedback control signal SFB is generated to trigger the power supply circuit to raise or maintain the power voltage VLED.

In the embodiment shown in FIG. 4, the feedback controller 115 is included in the latest driving circuit 110c, but the present disclosure is not limited thereto. In other embodiments, the functions of the feedback controller 115 can be integrated into the power supply circuit 120, and the output data SDO are directly transmitted to the power supply circuit 120 from the driving circuit 110c.

In some embodiments, the serial input data SDI and the output data SDO are transmitted among the driving circuits 110a, 110b, and 110c through a serial transmission in a time-dividing manner. In other words, the serial input data SDI and the output data SDO can be transmitted through only one line, instead of two independent lines.

For most display devices on the market, the driver integrated circuits (IC) that control the currents passing through the light emitting diodes (LEDs) in the display device need a common bus system in order to communicate information about whether the driving voltage is large enough to drive the LEDs. In this approach, extra pins are required for all driver ICs in order to communicate through a common bus system that is different and independent from the driver ICs′ input/output interface, and thus the cost and complexity to manufacture the driver ICs increase.

Thus, the power voltage VLED can be modulated according to the output data SDO. It is worth noted that the configuration between the driving circuit 110c and the power supply circuit 120 does not intend to limit the present disclosure. Person having ordinary skills in the art can use different configuration between the driving circuit 110c and the power supply circuit 120 and still implement the disclosed driving circuits 110 configured to modulate the power voltage VLED. In the embodiment where the output data SDO is digital data, the feedback generator 115 can be further configured to transform the output data SDO into analog data for the purpose of modulating the power voltage VLED.

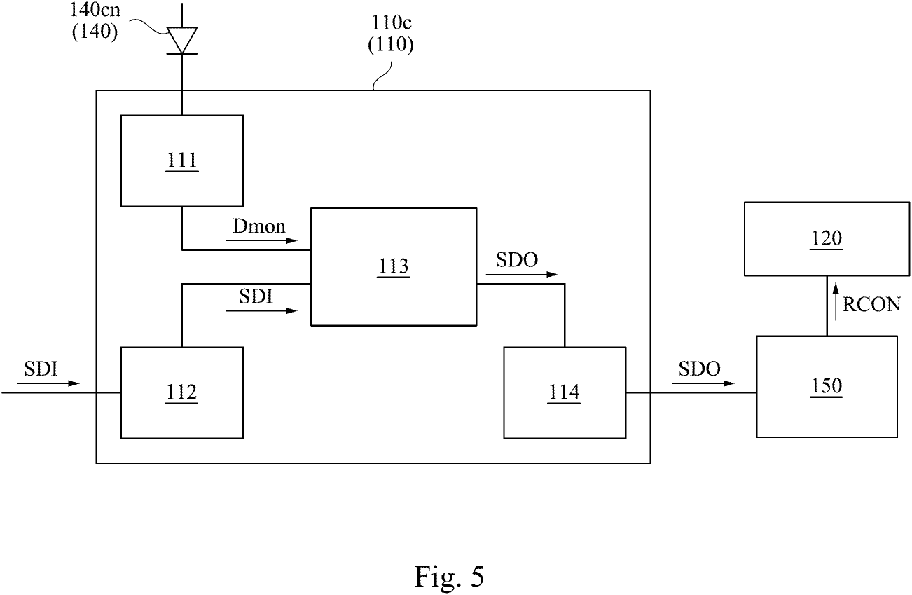

Please refer to FIG. 5. FIG. 5 is a circuit diagram of the driving circuit 110c in accordance with some embodiments of the present disclosure. In one embodiment, the driving circuit 110c does not have the feedback generator 115 shown in FIG. 4, and the output data SDO is transmitted to a microcontroller unit (MCU) 150. The microcontroller unit 150 determines whether the power voltage VLED needs to be stepped up according to the output data SDO and then transmits a raise control signal RCON to the power supply circuit 120. The power supply circuit 120 raises or maintains the power voltage VLED based on the raise control signal RCON.

In conclusion, the driving circuits 110 in the various embodiments of the present disclosure can transmit the information regarding the monitored voltage of the corresponding LEDs 140 through the serial input interface 112 and the serial output interface 114. The serial input interface 112 and the serial output interface 114 and others alike are normally included in most driving circuits, but in most cases they transmit only the display data DD configured to control the current of the LEDs coupled to the driving circuits. On the contrary, in the embodiments of the present disclosure, the serial input interface 112 and the serial output interface 114 are also configured to transmit the information regarding whether the power voltage VLED should be raised.

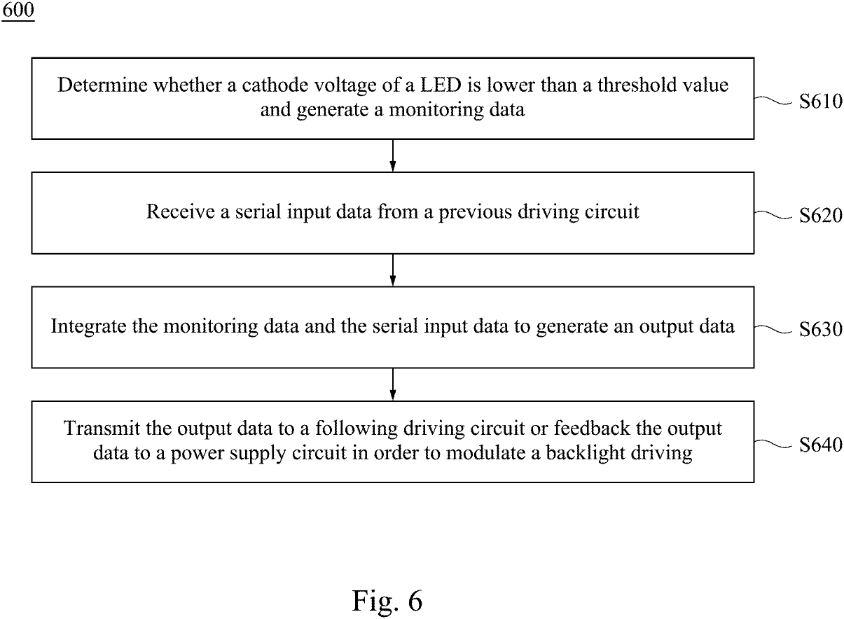

The present disclosure also provides a voltage modulation method. Please refer to FIG. 6. FIG. 6 is a flowchart of a voltage modulation method 600 in accordance with some embodiments of the present disclosure. The voltage modulation method 600 includes steps S610, S620, S630, and S640. These steps can be performed through the configurations shown in the previous embodiments of the present disclosure.

The step S610 is to determine whether a cathode voltage of a light emitting diode is lower than a threshold value and generate a monitoring data. For example, in the embodiment shown in FIG. 2, the comparator 111 determines whether the cathode voltage of the LED 140bn is lower than the threshold value and generates the monitoring data Dmon accordingly.

In one embodiment, the monitoring data has a first level in response to the cathode voltage of the light emitting diode being lower than the threshold value, and the monitoring data has a second level in response to the cathode voltage of the light emitting diode being higher than the threshold value. Detailed description of the previous embodiments can be referred.

The step S620 is to receive a serial input data from a previous driving circuit. For example, in the embodiment shown in FIG. 2, the serial input interface 112 receives the serial input data SDI from the driving circuit 110a and passes such data to the integrating unit 113.

The step S630 is to integrate the monitoring data and the serial input data to generate an output data. For example, in the embodiment shown in FIG. 2, the integrating unit 113 integrates the monitoring data Dmon and the serial input data SDI and then generates the output data SDO.

In one embodiment, the output data has the first level in response to the monitoring data having the first level or the serial input data having the first level, and the output data has the second level in response to the monitoring data having the second level and the serial input data having the second level. Detailed description of the previous embodiments can be referred.

The step S640 is to transmit the output data to a following driving circuit or to feedback the output data to a power supply circuit in order to modulate a power voltage VLED that the power circuit provides to the light emitting diode. For example, in the embodiment shown in FIG. 2, the serial output interface 114 transmits the output data SDO to the driving circuit 110c. In another example, as shown in FIG. 4, the feedback generator 115 feedbacks the output data SDO to the power supply circuit 120. However, in the two examples, the goal is the same - to modulate the power voltage VLED that the power circuit 120 provides to the LEDs 140.

In one embodiment, the voltage modulation method 600 further includes transmitting the output data to a microcontroller unit configured to determine whether the power voltage needs to be stepped up according to the output data and to transmit a raise control signal to the power supply circuit. For example, as in the embodiment shown in FIG. 5, the output data SDO is transmitted to the microcontroller unit 150, and the microcontroller unit 150 transmits the raise control signal RCON to the power supply circuit 120. Detailed description of the previous embodiments can be referred.

In one embodiment, the voltage modulation method 600 further includes receiving a display data from the previous driving circuit and transmitting the display data to the following driving circuit. The display data is configured to control a current passing through the light emitting diode in this embodiment. For example, as in the embodiments shown in FIG. 2, FIG. 4, and FIG. 5, the serial input interface 112 receives the display data DD and transmits it to the serial output interface 114. Detailed description of the previous embodiments can be referred.

In one embodiment, integrating the monitoring data and the serial input data to generate the output data further includes bypassing a display data carried in the serial input data as the output data during a first period and combining the monitoring data with the serial input data as the output data during a second period. The first period and the second period do not overlap. For example, as in the embodiments shown in FIG. 2 and FIG. 3A, the integrating unit 113, during the first period P1, bypasses the display data DD carried in the serial input data SDI as the output data SDO and, during the second period P2, combines the monitoring data Dmon (which is the monitoring data DmonB during the second period P2) with the serial input data SDI(which is the monitoring data DmonA during the second period P2) as the output data SDO (which is the monitoring data DmonC during the second period P2).

In conclusion, through the voltage modulation method 600, information about voltage of the LEDs coupled to different driving circuits can be combined together and passed to a power supply circuit of a display device so that the power supply circuit can modulate the driving voltage accordingly.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A driving circuit, configured to couple to a light emitting diode and a power supply circuit and modulate the power supply circuit for providing power to the light emitting diode, the driving circuit comprising:
a comparator, configured to couple to the light emitting diode and determine whether a cathode voltage of the light emitting diode is lower than a threshold value and generate a monitoring data;
a serial input interface, configured to receive a serial input data from a previous driving circuit; and
an integrating unit, coupled to the comparator and the serial input interface and configured to integrate the monitoring data and the serial input data to generate an output data, the output data being transmitted to a following driving circuit or feedbacked to the power supply circuit in order to modulate a power voltage provided by the power circuit to the light emitting diode.

2. The driving circuit of claim 1, wherein:
the monitoring data has a first level in response to the cathode voltage of the light emitting diode being lower than the threshold value; and
the monitoring data has a second level in response to the cathode voltage of the light emitting diode being higher than the threshold value.

3. The driving circuit of claim 2, wherein:
the integrating unit generates the output data as the first level in response to the monitoring data having the first level or the serial input data having the first level; and
the integrating unit generates the output data as the second level in response to the monitoring data having the second level and the serial input data having the second level.

4. The driving circuit of claim 3, wherein the output data generated by the integrating unit with the first level is configured to trigger the power supply circuit to raise the power voltage.

5. The driving circuit of claim 3, wherein the output data generated by the integrating unit with the second level is configured to trigger the power supply circuit to maintain the power voltage.

6. The driving circuit of claim 1, further comprising:
a feedback output interface, configured to transmit the output data to the power supply circuit.

7. The driving circuit of claim 1, further comprising:
a serial output interface, configured to transmit the output data to the following driving circuit.

8. The driving circuit of claim 7, further comprising:
a microcontroller unit, coupled between the serial output interface and the power supply circuit and configured to determine whether the power voltage needs to be stepped up according to the output data and to transmit a raise control signal to the power supply circuit.

9. The driving circuit of claim 7, wherein the serial input interface is configured to receive display data from the previous driving circuit, the serial output interface is configured to transmit the display data to the following driving circuit, and the display data is configured to control a current passing through the light emitting diode.

10. The driving circuit of claim 1, wherein the integrating unit integrates the monitoring data and the serial input data in a time-dividing manner by:
bypassing display data carried in the serial input data as the output data during a first period;
combining the monitoring data with the serial input data as the output data during a second period; and
the first period and the second period do not overlap.

11. The driving circuit of claim 10, wherein the driving circuit receives a control signal, the integrating unit operates in the second period in response to the control signal having a first level, and the integrating unit operates in the first period in response to the control signal having a second level.

12. A voltage modulation method of a light emitting diode, comprising:
determining whether a cathode voltage of the light emitting diode is lower than a threshold value and generating a monitoring data;
receiving a serial input data from a previous driving circuit;
integrating the monitoring data and the serial input data to generate an output data; and
transmitting the output data to a following driving circuit or feeding back the output data to a power supply circuit in order to modulate a power voltage that the power circuit provides to the light emitting diode.

13. The voltage modulation method of claim 12, wherein:
the monitoring data has a first level in response to the cathode voltage of the light emitting diode being lower than the threshold value, and
the monitoring data has a second level in response to the cathode voltage of the light emitting diode being higher than the threshold value.

14. The voltage modulation method of claim 13, wherein:
the output data has the first level in response to the monitoring data having the first level or the serial input data having the first level; and
the output data has the second level in response to the monitoring data having the second level and the serial input data having the second level.

15. The voltage modulation method of claim 12, further comprising:
transmitting the output data to a microcontroller unit configured to determine whether the power voltage needs to be stepped up according to the output data and to transmit a raise control signal to the power supply circuit.

16. The voltage modulation method of claim 12, further comprising:
receiving display data from the previous driving circuit; and
transmitting the display data to the following driving circuit;
wherein the display data is configured to control a current passing through the light emitting diode.

17. The voltage modulation method of claim 12, wherein integrating the monitoring data and the serial input data to generate the output data further includes:
bypassing display data carried in the serial input data as the output data during a first period; and
combining the monitoring data with the serial input data as the output data during a second period;
wherein the first period and the second period do not overlap.

18. The voltage modulation method of claim 17, further comprising:
receiving a control signal;
operating in the second period in response to the control signal having a first level; and
operating in the first period in response to the control signal having a second level.
